(19) United States
(12) Patent Application Publication
(10) Pub. No.: US 2015/0143930 A1
(43) Pub. Date: May 28, 2015

(54) Method For Containing A Sample Of A Gaseous Mixture Flowing In A Pipeline And Corresponding Device

(71) Applicants: Ecomesure, Janvry (FR); Veolla Proprete, Nanterre (FR)

(72) Inventors: Xavier Chaucherie, Versailles (FR); David Ledur, Boulogne Billancort (FR)

(73) Assignees: Veolia Proprete, Nanterre (FR); Ecomesure, Janvry (FR)

(21) Appl. No.: 14/406,396

(22) PCT Filed: Jun. 11, 2013
(86) PCT No.: PCT/FR2013/051351

§ 371 Date: Dec. 8, 2014

(30) Foreign Application Priority Data
Jun. 11, 2012 (FR) 1255426

(51) Int. Cl. G01N 1/22; G01N 1/38

(52) U.S. Cl. CPC G01N 1/2247; G01N 1/38; G01N 2001/2264
USPC 73/864.73

(57) ABSTRACT

A method of containing a sample of a gaseous mixture flowing in a pipeline at a flow rate, for analysis of same by at least one analyzer of which the operating conditions are not compatible with the physico-chemical conditions of the gaseous mixture in the pipeline is described. The method includes collecting a sample of the gaseous mixture in the pipeline, diluting the collected sample with a dry dilution gas, at a dilution temperature (T_dil) equal to or close to the temperature (T_prel) of the gaseous mixture in the pipeline during the collection step, and conveying the collected and diluted sample out of the pipeline via an outlet pipe for analysis of the same by said analyzer.

### BACKGROUND

The present invention concerns the field of the channeled emissions of gaseous mixture, that is to say a flow of gaseous mixture in a pipeline.

The gaseous mixture may be either free of particles, or comprise particles, for example an aerosol or fumes produced by a combustion. For brevity, depending on the range of temperatures used in the thermal treatment from which the fumes are produced, it is meant by combustion, a combustion, a pyrolysis or a gasification.

### SUMMARY

Different types of industries are concerned by the channeled emissions, for example pharmaceutical industry, building and public works (cement works), domestic waste treatment, wood industry, steel industry, etc. Depending on the nature of the fuel-oxidant pair implemented during a combustion for example, the chemical composition and the physico-chemical characteristics (temperature, humidity, concentration, grain size distribution) of the fumes may be diverse.

The fumes, exiting the combustion, are channeled in a pipeline, for example a chimney, to be then typically rejected in the open air or treated by different methods.

To optimize the combustion or the treatment prior or after the combustion, or to comply with the environmental regulatory constraints, it seems useful to analyze the gaseous mixture.

Hence, a sample should generally be collected and analyzed by an analyzer, typically a gas analyzer or a particle analyzer. However, the operating conditions of the current analyzers are not necessarily compatible with the thermodynamic conditions of the flow nor with the physico-chemical characteristics of the gaseous mixture of some channeled emissions. In particular, some analyzers may not operate at the values of temperature, hygrometry, and even particles or gas concentration which prevail in the pipeline.

Typically, to date, two types of solutions exist: one consisting of performing, manually or automatically, measurements in situ in a pipeline at high temperatures, thereby implying having an analyzer that is specific, complex and expensive, and of which measurements, which are continuously performed, are inherently averaged; the other consisting of performing measurements at ambient temperatures, manually or automatically, with an analyzer external to the pipeline, on a sample collected in the pipeline. In this last case, the representativeness of the sample is not always satisfactory.

To date, to be in compliance with the measuring conditions of external analyzers, most often, it is necessary to dilute the sample, typically with dilution air, so as to give it a temperature or a humidity compatible therewith.

Furthermore, in the case of the particles, it is necessary to heat the dilution air (or the nitrogen) coming from a pump or a compressor or a Venturi injector or a compressed air network, outside of the conduit or chimney thereby making the device relatively heavy to implement. Also, it is necessary to measure in parallel the temperature of the chimney to adjust the heating temperature of the dilution air which may be substantially different from the actual temperature of the dilution air.

The present invention aims to overcome these drawbacks by proposing a solution allowing extracting and conditioning a representative sample, so as to be able to analyze said sample with an external analyzer.

With this objective in view, according to one of its objects, the invention concerns a method for conditioning a sample of a gaseous mixture flowing in a pipeline at a flow velocity, in view of analyzing it by at least one analyzer the operating conditions of which are not compatible with the physico-chemical conditions of the gaseous mixture in the pipeline,

the method comprising steps consisting of:

collecting a sample representative of the gaseous mixture and the particles possibly contained therein in the pipeline, without cut-off nor filtering,

diluting the collected sample with a dry dilution gas, in a first dilution chamber located in the pipeline, at a dilution temperature T_dil equal or close to the temperature T_prel of the gaseous mixture in the pipeline during the collection step; and

conveying the collected and diluted sample toward the outside of the pipeline through an outlet tube in view of analyzing it by said analyzer.

There may be further provided a step consisting of lowering the temperature of said collected and diluted sample.

Preferably, the dilution step is performed in a dilution chamber located in the pipeline.

Preferably, the dilution step is performed with a dilution gas having a composition different from that of said sample.

There may be further provided a step of controlling the temperature of the collected and diluted sample.

There may be further provided a step of setting the temperature of the dilution gas, prior to the dilution step, in particular by heat transfer between the gaseous mixture in said pipeline and a dilution pipeline located at least partially in said pipeline, through which the dilution gas is conveyed for the dilution step.

There may be further provided a step consisting of analyzing said sample by at least one analyzer, in particular external to the pipeline.

Preferably, the collection step is carried out iso-kinetically with respect to the flow velocity.

It may also be provided that the method further comprises a cut-off step, in particular subsequent to the collection step.

According to another of its objects, the invention concerns a device for conditioning a sample collected in a gaseous mixture flowing in a pipeline at a flow velocity, in view of analyzing it by at least one analyzer the operating conditions of which are not compatible with the physico-chemical conditions of the gaseous mixture in the pipeline,

The device comprising:

a first dilution chamber intended to be located in the pipeline, for diluting the sample with a dilution gas, at a dilution temperature T_dil equal or close to the temperature T_prel of the gaseous mixture in the pipeline,

the dilution chamber comprising:

a collection inlet by which the collected sample is conveyed in the first dilution chamber,

a dilution inlet, distinct from the collection inlet, for conveying a dilution gas, and

an outlet tube for conveying the collected and diluted sample from the first dilution chamber toward the outside of said chamber in view of analyzing it by said analyzer.

The device according to the invention is likely to carry out the method according to the invention.

Within the meaning of the present invention, the terms “intended to” and “configured for” are understood indistinctly.

In one embodiment, it is provided that the device further comprises:

a collection tube mounted on the collection inlet, or

a set of at least one collection spout in which each spout may be mounted on the collection inlet, or

a set of at least one collection tube one of which is mounted on the collection inlet, and a set of at least one collection spout, in which each spout may be mounted on a respective collection tube or on a same collection tube,

in which the collection tube is straight, and its own axis of elongation is coincident with that of the dilution chamber, and parallel to the direction of the gaseous flow in the pipeline.

The collection spout allows collecting directly, that is to say without cut-off nor filtering, a sample of said gaseous mixture iso-kinetically with respect to the flow velocity, in order to preserve the grain size distribution of the gaseous mixture. The collection spout does not modify the flow, that is to say the behavior of the gaseous mixture and of the particles possibly contained therein. The collected sample is hence representative of the gaseous mixture and the particles possibly contained therein.

Preferably, the geometry of the collection tube, the set of at least one collection spout and of the outlet tube is configured to make the flow of the collected laminar sample, and

the internal geometry of the first dilution chamber is such that it allows creating turbulences therewithin.

It may be provided that the first dilution chamber has an ellipsoidal or biconical internal geometry with two revolving cones mounted at the ends of a cylinder and the heights of which are coincident with each other.

There may be provided a second dilution chamber, located along the outlet tube, said outlet tube constituting the collection inlet of said second dilution chamber.

In one embodiment, the second dilution chamber is intended to be located inside the pipeline. In another embodiment, the second dilution chamber is intended to be outside the pipeline.

There may be further provided, for example at the end of the outlet tube (on the tube), a multi-branch intermediate part connected to the outlet tube, the intermediate part comprising at least three branches, one main branch intended to be connected to the outlet tube, and at least one secondary branch, intended to be connected to at least one analyzer. Preferably, there is further provided at least one other secondary branch intended to be connected to an outlet for discharging the excess of gaseous mixture, for example a pump or a Venturi injector ensuring the collection of the possible surplus of diluted gas mixture, depending on the dilution ratio predetermined by an operator.

There may be further provided an electrical resistance inserted in a double jacket for controlling the temperature of the collected and diluted sample which passes through the outlet tube.

There may be further provided a heating chamber, preferably placed in the pipeline, for setting the temperature of the dilution gas before its introduction in the first dilution chamber.

There may be further provided at least one analyzer, for analyzing the collected and diluted sample conveyed by the outlet tube.

It may be provided that:

when the temperature of the gaseous mixture flowing in the pipeline is lower than a threshold value, for example 300° C., said analyzer is intended to be positioned in the pipeline or outside it, and

when the temperature of the gaseous mixture flowing in the pipeline is higher than the threshold value, for example 300° C., at least one analyzer is intended to be positioned out of the pipeline.

It is possible to place at the outlet a plurality of analyzers which allows analyzing both the particles and the gases.

According to another of its objects, the invention concerns a system for conditioning a sample collected in a gaseous mixture flowing in a pipeline comprising:

a conditioning device according to the invention,

said pipeline, and

a source of dry dilution gas, said source being external to the pipeline.

Preferably, said dilution gas comprises nitrogen.

Preferably, when the gaseous mixture flowing in the pipeline comprises the particles, the dilution gas is further clean.

The invention is applicable irrespective of the diameter of particles.

Thanks to the invention, it is possible to use analyzers operating at ambient conditions or conditions called “chimney” conditions (the temperature of which is lower than 300° C.), in particular in temperature and relative humidity, for gaseous mixtures produced from a pipeline in which these conditions of temperature or relative humidity are much higher.

Other characteristics and advantages of the present invention are described in the attached claims and will become more apparent upon reading the following description given by way of illustrative and non-limiting example and with reference to the appended figures in which:

### BRIEF DESCRIPTION OF THE DRAWINGS

FIG. 1 illustrates an embodiment of the device according to the invention,

FIG. 2 illustrates an embodiment of the method according to the invention, and

FIG. 3 illustrates a longitudinal section of an embodiment of a multi-branch intermediate part according to the invention connected to an outlet tube.

### DETAILED DESCRIPTION

### Gaseous Mixture

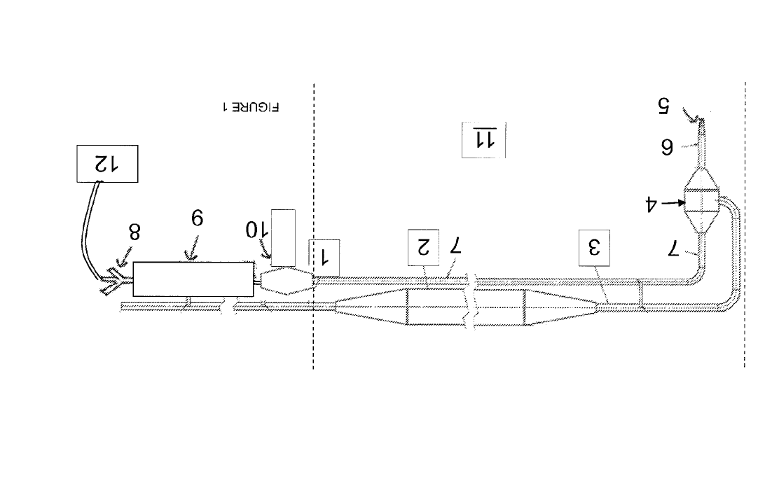

A gaseous mixture passes, at a flow velocity, through a pipeline 11, the walls of which are symbolized by dotted lines in FIG. 1. Generally, the gaseous mixture may be a pure gas or a mixture of gases. It may also comprise particles (dust) the concentration and the nature of which vary depending on the origin of said mixture, for example the combustion or the process from which they are produced. In particular in the case of fumes, the particles are numerous and with different size (equivalent diameter).

We define, by the grain size distribution the distribution of these particles according to their diameter, whether it is the equivalent, the geometric, the aerodynamic, the optical or the electrical mobility diameter.

For brevity, there is here described only a gaseous mixture in the form of industrial fumes, conveyed in a pipeline in the form of a chimney at temperatures called chimney temperatures, that is to say at temperatures comprised between 50° C. and 300° C.

However, the invention is not limited to these embodiments. In particular, it is not limited to fumes produced from a combustion. It may be implemented for gases free of particles.

It may also be implemented for ranges of ambient temperatures (10° C.-40° C.), for example for conditioning a gaseous mixture in a general ventilation network. For example, the gaseous mixture is an aerosol. Without particles, the gaseous mixture may be of the diffuse emission type, humidity-laden and/or hot that is to say at a temperature comprised between 40° C. and 70° C.

It may also be implemented for conditions called process conditions, that is to say the temperature of which is comprised between 300° C. and 1100° C.

Collection

One step consists of collecting 100 in the pipeline a sample of the gaseous mixture in view of analyzing it by an analyzer 12 of which at least one of its operating conditions among a set comprising the temperature, the relative humidity and the concentration of particles is not compatible with the corresponding values of the gaseous mixture in the pipeline.

The collected sample is sought to be as representative as possible, that is to say that it preserves the grain size distribution of the gaseous mixture from which it is produced, even if its particles concentration may be lower.

Indeed, a representative collected sample allows measuring in real time, and even better knowing and understanding, for example the phenomena at the origin of the formation of the particles. Hence, in the case of a combustion, that allows thus optimizing the combustion itself.

Advantageously, the collection step 100 preserves the grain size distribution of the gaseous mixture, that is to say the grain size distribution of the particles distribution and the proportion of each gas of the gaseous mixture.

The term cut-off refers to a step consisting of separating the particles according to their diameter in order to preserve only those which have a diameter smaller than a threshold value called cut-off diameter, thanks to a cut-off device, which is other than a filter.

For gaseous mixtures comprising particles, a cut-off step may be carried out. Preferably, the cut-off step is carried out after the collection step 100 and before the dilution step 110. To this end, there is provided for example a cyclone or an impactor installed upstream of the collection inlet, for example on the collection tube 6 downstream of the collection spout 5.

Advantageously, it is not necessary to carry out the cut-off step upstream of the collection step 100, which allows guaranteeing an iso-kinetic collection.

Furthermore, the collection is advantageously performed directly in the pipeline 11, iso-kinetically with respect to the flow velocity of the gaseous mixture. Therefore, it is performed in the temperature conditions thereof, allowing guaranteeing the collection of a representative sample at the thermal level since the latter does not undergo thermal disturbances at this stage.

The collection performed iso-kinetically with respect to the flow velocity, in combination with the absence of cut-off, allows preserving the grain size distribution, hence guaranteeing the collection of a representative sample with regard to this criterion.

To ensure that the collection is iso-kinetic, there may be provided a collection spout 5 the diameter of which is predetermined, for example by calculation. The calculation of the diameter depends in particular on the thermo-aeraulic conditions in the pipeline. The calculation may be performed according to a standard, for example the standard NFX-44052 in France. The collection spouts are known and examples may be found at the address http://www.hi-q.net/products/stack-fume-hood-sampling/iso-kinetic-gas-sampling-probes/default.html

The collection spout is for example screwed on a thread equipping a collection tube 6, preferably straight, mounted directly on a dilution chamber, described later and exhibiting the same inner inlet diameter as that of the straight tube. Preferably, for flow rates of dilution gas injection lower than 50 l/min, the inner diameter of this straight tube is of 6 mm for a length at least 10 times larger than the inner diameter of this straight tube. The advantage of the straight tube 6, of which the own axis of elongation is preferably coincident with that of the dilution chamber 4 described below, and parallel to the direction of the gaseous flow in the pipeline 11, is that it limits the risks of sedimentation of the particles. Preferably, the flow velocities are at least higher than 5 m/s. In particular, flow velocities higher than 10 m/s are provided, to limit as much as possible the deposits.

In one embodiment, there is provided a plurality of interchangeable spouts, for example with diameters comprised between 2 and 12 mm by steps of 1 mm, which allows for example to be able to easily and quickly change the spout in case of a variation in the flow rate.

Dilution

There is provided a step of diluting 110 the collected sample.

The dilution allows decreasing, according to a given dilution ratio or factor, the concentration in particles or in gas and/or the humidity of the collected sample. Furthermore, hot dilution with clean and dry air allows preserving the gaseous mixture and allows, in the second dilution chamber 10 described later, decreasing the temperature of the diluted sample without risk of condensation.

Advantageously, there is provided a dilution factor comprised between 2 and 200 and more preferably between 2 and 100. The value of the dilution factor is the ratio of the gaseous flow rates at the inlet of the dilution chamber (iso-kinetic collection and dilution gas) and at its outlet.

The dilution factor R is calculated for example as follows:

R=(D2+D3)/[(D2+D3)−D1] with

D1 the flow rate of the dilution gas, in the dilution inlet described later,

D2 the flow rate of the discharged excess of gaseous mixture, and

D3 the suction flow rate of the analyzer.

As described later, the dilution chamber is connected to an outlet tube, in-turn connected to a multi-branch part one branch of which allows conveying the gaseous mixture toward at least one analyzer according to a flow rate D3 and another branch allows conveying the flow rate D2 in excess toward an outlet.

The volume of the dilution chamber does not directly affect the calculation of R but this volume is defined at a minimal level so that the flow is turbulent therewithin.

The dilution step 110 consists of diluting the collected sample with a clean and dry dilution gas. Preferably, the dilution gas comprises nitrogen or is nitrogen. For example the dilution gas is compressed air, which may come for example from the compressed air network on the industrial site on which the collection is performed.

By clean, it is meant a dilution gas the dust concentration of which is lower than a predetermined threshold of that of the sample. In this instance, the threshold is of 1%.

By dry, it is meant a dilution gas the relative humidity (or the dew point at a determined temperature) of which is lower than a predetermined threshold of that of the sample. In this instance, the threshold is of 0.5%.

An inlet tube 1, straight in this instance, which allows reducing pressure drops and making the flow more laminar, is configured to convey the dilution gas toward the first dilution chamber 4 described below, from an external source to the pipeline, for example by a pump, a compressor, a Venturi injector or a compressed air or nitrogen network.

The flow rate of the clean and dry dilution gas is calculated and adjusted at least depending on the desired dilution ratio.

Advantageously, the dilution step is performed at a dilution temperature T_dil equal or close to the temperature T_prel of the gaseous mixture in the pipeline during the collection step. By “close”, it is meant a temperature comprised between the temperature of the gaseous mixture in the pipeline during the collection step and this same temperature minus a predetermined value, for example 5% of this same temperature. In this instance, T_dil is comprised in the set [T_prel; T_prel-X % (T_prel)] with for example X=5. Such a dilution temperature close to the collection temperature allows avoiding a possible condensation of the sample, ensuring that the dilution is performed in the same physico-chemical conditions prevailing in the pipeline and ensuring the representativeness of the diluted sample.

The dilution step is performed at least in a first dilution chamber 4.

Dilution Chamber

Advantageously, the dilution chamber 4 is located in the pipeline, which allows optimizing the thermal energy since the thermal energy of the pipeline allows heating said dilution chamber 4, it is not necessary to heat the latter by additional heating means. This localization also allows guaranteeing that the dilution temperature is close to the collection temperature.

Advantageously, the collection spout 5 and the dilution chamber 4 are as close as possible to each other. For example, a collection spout is mounted on the dilution chamber, which allows having a distance between the collection and the inside of the dilution chamber in the order of the length of the spout, namely 3 to 10 centimeters. Such a proximity allows avoiding any possible transformation of the sample (in the physico-chemical sense) and limits as much as possible the risks of deposits.

The dilution chamber 4 comprises:

a collection inlet for the collected sample,

a dilution inlet, distinct from the collection inlet, for the dilution gas (heated beforehand as described below in a heating chamber), and

an outlet, connected to an outlet tube comprising the diluted sample in a maximum ratio of 1:300.

The collection inlet is connected to a device for collecting the sample.

In particular in the case where the gaseous mixture comprises particles, the collection device comprises the collection spout 5. The collection spout 5 may be mounted directly on the collection inlet of the dilution chamber 4. It may also be mounted on the collection tube 6, the collection tube 6 being then mounted on the collection inlet of the dilution chamber 4.

In particular in the case where the gaseous mixture is free of particles, the collection spout 5 is not necessary and the collection device may comprise only the collection tube 6 mounted on the collection inlet of the dilution chamber 4.

Preferably, the shape of the dilution chamber exhibits an axis of elongation, in this instance parallel to the axis of elongation of the pipeline. Preferably, the collection inlet is also located along this axis of elongation, which facilitates the collection and allows obtaining a representative sample. In this instance, the collection spout exhibits an axis of elongation, coincident with that of the dilution chamber. In this instance the collection spout exhibits a generally tubular shape. Other shapes can be implemented, for example depending on the flow velocity and the flow rate of the used analyzer, the spout may be conical.

Preferably, for the dilution chamber, the different tubes ensure the flow or the collection spout, elbows or angles are limited, which allows avoiding sedimentation of the particles, also thanks to a flow that is as laminar as possible.

The internal geometry of the dilution chamber 4 depends in particular on the inflow rates and on the outflow rate. By its shape and its volume, the internal geometry is such that it allows creating turbulences or vortex therewithin. Preferably, it is provided that the internal shape contains as little angles as possible, or even none, which, as for the collection spout, limits the risk of deposition of the particles therein.

For example, there is provided an ellipsoidal or biconical geometry with two revolving cones mounted at the ends of a cylinder and the heights of which are coincident with each other, and in this instance also coincident with the axis of elongation of the dilution chamber. Advantageously, the inner angle of the two cones is of 30°, which limits the risks of sedimentation of particles and also allows making laminar the flow at the outlet of the chamber.

Preferably, for flow rates of dilution gas injection lower than 50 l/min, we may provide that:

the diameter of the cylinder located between the two cones of the dilution chamber is at least 7 times larger than the diameter of the collection inlet,

the outlet diameter of the dilution chamber (to which an outlet tube 7, which will be described later, is connected) is equal to the diameter of the collection inlet, which allows obtaining a significant flow velocity at the outlet, for example at least higher than 5 m/s and preferably higher than 10 m/s.

At the outlet of the dilution chamber, the flow velocity is determined by the shape of the chamber, the diameter of the outlet tube 7 and the inflow rates (collection and dilution gas). We advantageously provide that the chamber and the outlet tube 7 are sized so as to obtain, for the considered inflow rates, a significant flow velocity, that is to say higher than a threshold value, which allows driving the large particles. In this instance, there is provided a flow velocity at the outlet of the dilution chamber at least higher than 5 m/s and preferably higher than or equal to 10 m/s.

The outlet tube 7 allows conveying 130 the collected and diluted sample from the dilution chamber 4 toward the outside of the pipeline 11. It comprises a portion in the pipeline and a portion external to the pipeline. Preferably and for flow rates of dilution gas injection lower than 50 l/min, the inner diameter of the tube 7 is of 6 mm.

Preferably, the outlet tube 7 exhibits, for the portion connected to the dilution chamber 4, an axis of elongation which is parallel, coincident in this instance, with the axis of elongation of the dilution chamber. This configuration allows in particular limiting the risks of pressure drops. To convey the collected and diluted sample toward the outside of the pipeline, the outlet tube 7 preferably exhibits few elbows, so as to also limit pressure drops and turbulences due to the elbows, in this instance, it is L-shaped.

The other end of the tube 7 is connected to one or several analyzers 12 of gas and/or particles, manual or automatic, placed outside of the pipeline 11.

There may be provided on the outlet tube 7, upstream of the analyzer 12, an intermediate part 8, in this instance a multi-branch part sometimes called “flow rate divider”, allowing to connect the outlet tube 7 to a pump or a Venturi injector ensuring the collection of the possible surplus of diluted gas mixture depending on the dilution ratio predetermined by an operator. It is preferably placed also outside of the pipeline.

The multi-branch intermediate part 8 comprises at least two branches, one branch connected to at least one analyzer, and the other branch connected to an outlet for discharging the excess of gaseous mixture.

In this instance, the multi-branch part 8 comprises three branches, one main branch 81 to be connected to the outlet tube 7, and two secondary branches 82, 83 one of which is connected to at least one analyzer 12 (equipped with a suction pump) and the other to an outlet for discharging the excess of gaseous mixture. Preferably, the main branch 81 exhibits an axis of elongation coincident with that of the outlet tube 7 on the portion where the multi-branch part 8 is mounted; and the secondary branches form a predetermined angle with the main branch, in this instance of 30 to 45° each, on either side of said axis of elongation.

Indeed, each analyzer has a nominal suction flow rate D3. Yet, the flow rate D7 in the outlet tube 7, hence in the main branch 81, is equal to the dilution flow rate plus the collection flow rate. This flow rate D7 is conventionally higher than the suction flow rate D3, we should in this case provide that the excess of gaseous mixture is discharged at a flow rate D2 equal to D7 minus D3.

In case of a plurality of analyzers, there may also be provided a plurality of secondary branches, each analyzer being individually connected to a respective secondary branch.

The section of the outlet tube 7 external to the pipeline is advantageously located in the open air, or in an external environment the temperature of which is lower than that of the inside of the pipeline. Thus, the outlet tube 7 may be not particularly thermally insulated, and thanks to heat exchanges (between the latter and said external environment), the temperature of the sample which passes through the outlet tube 7 is naturally lowered. This configuration allows carrying out quite simply, without additional cooling means, a step consisting of lowering the temperature 140 of said collected and diluted sample.

Depending in particular on the type of material used for the outlet tube, in this instance stainless steel, and/or of the length of the outlet tube 7, the temperature of the sample may be lowered down to the external environment temperature, that is to say to the operating conditions of most analyzers. Different types of material are usable for the outlet tube. For example other steels. It is also possible to use, according to the applications, titanium, quartz or ceramic. The used material should not chemically react with the gas which flows therewithin.

However, there may be provided a step of controlling 150 the temperature (cooling or warming) of the collected and diluted sample which passes through the outlet tube 7, for example by the use of cooling means (not illustrated), for example a fluid such as water or cold air flowing in a double jacket; or the use of an electrical resistance inserted in a double jacket 9 or even a fluid such as hot oil flowing in a double jacket, which allows maintaining the temperature of the collected and diluted sample at a predetermined value or range of values. That may be useful to preserve the representativeness of the diluted sample if an analyzer operates in a temperature range higher than the ambient/external environment temperature, for example for a range of temperatures from 10° C. to 40° C. or at a higher temperature, with measurements called “process” measurements thanks to analyzers equipped with measuring cells heated at 180° C., thereby avoiding condensation by remaining above the dew point.

Here, since the dilution is carried out with a dry gaseous mixture, even if the temperature of the sample is lowered after the dilution, the conditions thereof always remain above the dew point, thereby avoiding condensation.

Prior Temperature Setting

As previously seen, the dilution 110 is advantageously performed at the temperature of the collected sample. Indeed, if the dilution is performed at a temperature higher than the temperature of the pipeline, it requires a costly energy input when this temperature is high. And if the temperature is lowered before the dilution, there exists a problematic risk of condensation. Furthermore, decreasing or increasing the temperature may affect the physico-chemical composition of the collected fumes, for example the volatilization of chemical species, or the gas-particles conversion.

To this end, and in particular for pipeline temperatures higher than an ambient temperature (10° C., 40° C.), there may be provided a step 90 of setting the temperature of the dilution gas, prior to the dilution step, that is to say before its introduction in the first dilution chamber.

This temperature setting may be performed directly by the inlet tube 1 of the dilution gas, one portion of which is then located in the pipeline, or indirectly via a heating chamber 2 also preferably placed in the pipeline 11.

Thus, it is not necessary to implement additional external heating means, the dilution gas is heated by the thermal energy present in the pipeline and its temperature is equal or very close to the temperature prevailing in the pipeline, thereby avoiding condensation problems and optimizing energy by reducing the energy consumption of the whole.

This temperature setting prior to the dilution is thus performed by a device that is very simple, light and easy to implement.

In this instance the inlet tube 1 is connected to a heating chamber 2 inside the pipeline.

Preferably, the inner diameter of the inlet tube 1 is of 8 mm for flow rates of dilution gas injection lower than 50 l/min. Also, the distance between the inlet of the dilution gas injection and the inlet of the heating chamber 2 is at least 5 times larger than the inner diameter of the inlet tube 1 and hence the inner diameter of the inlet of the heating chamber 2.

Preferably, we provide that the heating chamber 2 allows setting the dilution gas at the temperature of the sample, in this instance at the temperature of the sample in the pipeline.

The heating chamber 2 may comprise baffles inside in order to increase the thermal contact surface and ensure the temperature setting of the dilution gas, delivered from outside, to the temperature of the pipeline.

The heating chamber 2 may have a biconical geometry. In this case, the inner angle of the two cones is preferably of 10°. In comparison with the inlet of the heating chamber, the flow velocities are significantly decreased so that the dilution gas flows slowly until the outlet and is at the temperature of the pipeline or very close thereto. The advantage of having these small angles from 10 to 20° (relative to the axis of elongation of the chamber) is to have a pressure drop as small as possible with a straight section making the flow laminar, for even less pressure drop.

Preferably and for flow rates of external dilution gas injection lower than 50 l/min, the inner inlet diameter of the heating chamber 2 is of 8 mm and the inner diameter of the straight section located between the two cones of the heating chamber 2 is at least 8 times larger than the inner inlet diameter of the heating chamber 2 and for a length at least 80 times larger than the same inner diameter of the inlet of the heating chamber 2. The outlet diameter of the heating chamber 2 is also preferably identical to the inlet diameter, namely of 8 mm, which limits pressure drops, as previously seen.

The outlet of the heating chamber is connected to an intermediate tube 3, U-shaped in this instance, the other end of which is connected to the inlet of the dilution chamber 4. The intermediate tube 3 allows conveying the hot dilution gas to the inlet of the dilution chamber 4.

Preferably, for flow rates of dilution gas injection lower than 50 l/min, the inner diameter of the intermediate tube 3 is of 8 mm with:

a straight section with a length at least 20 times larger than the inner diameter of this tube,

an elbow with a curvature radius equal to 20 mm,

a straight section with a length at least equal to 10 times the inner diameter of this tube, and

an elbow with a curvature radius equal to 20 mm.

Remote Analysis of the Collection

There may be provided a step of physico-chemical analysis 160 of the sample, by at least one analyzer remotely located, out of the pipeline, for analyzing the collected and diluted sample conveyed by the outlet tube 7.

The invention is not limited to the previously described embodiments.

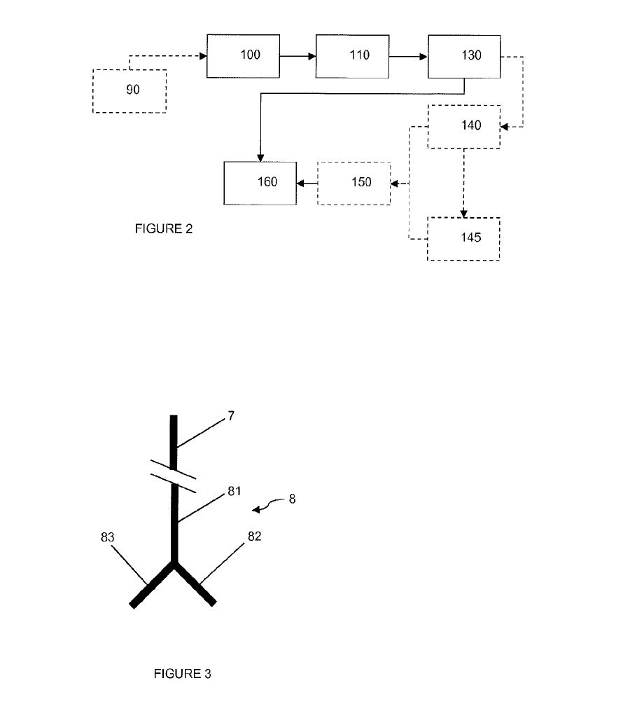

Referring to FIG. 2 in which the dotted lines symbolize the optional nature of the steps, there may be provided for example a second dilution step 145. It is preferably prior to the step 150 of controlling the temperature of the sample, by a second dilution chamber 10, located along the outlet tube 7, in its portion internal or external to the pipeline. In this instance, the second dilution chamber 10 is biconical and with the same dimensions as the first dilution chamber 4. Preferably, the first dilution chamber 4 and the second dilution chamber 10 are fed with the same dilution gas.

1.-16. (canceled)

17. A method for conditioning a sample of a gaseous mixture flowing in a pipeline at a flow velocity for analyzing it with at least one analyzer, the operating conditions of which are not compatible with the physico-chemical conditions of the gaseous mixture in the pipeline, the method comprising:
collecting a sample representative of the gaseous mixture and the particles possibly contained therein in the pipeline, without cut-off or filtering;
diluting the collected sample with a dry dilution gas in a first dilution chamber located in the pipeline at a dilution temperature (T_dil) equal or close to a temperature of the gaseous mixture in the pipeline during the collection step (T_prel); and
conveying the collected and diluted sample toward the outside of the pipeline through an outlet tube in view of analyzing it by said analyzer.

18. The method according to claim 17, further comprising lowering temperature of said collected and diluted sample.

19. The method according to claim 17, further comprising controlling a temperature of the collected and diluted sample.

20. The method according to claim 17, further comprising setting the temperature of the dilution gas, prior to the dilution step, by heat transfer between the gaseous mixture in the pipeline and a dilution pipeline located at least partially in the pipeline, through which the dilution gas is conveyed for the dilution step.

21. The method according to claim 17, further comprising analyzing the sample with at least one analyzer.

22. The method according to claim 17, wherein the collection step is carried out iso-kinetically with respect to the flow velocity and the method further comprises an optional cut-off step subsequent to the collection step.

23. A device for conditioning a sample collected in a gaseous mixture flowing in a pipeline at a flow velocity for analyzing it by at least one analyzer, the operating conditions of which are not compatible with the physico-chemical conditions of the gaseous mixture in the pipeline, the device comprising:
a first dilution chamber configured to be located in the pipeline to dilute the sample with a dilution gas at a dilution temperature (T_dil) equal or close to a temperature of the gaseous mixture in the pipeline (T_prel);
the first dilution chamber including;
a collection inlet by which the collected sample is conveyed in the first dilution chamber,
a dilution inlet, distinct from the collection inlet, for conveying a dilution gas,
an outlet tube for conveying the collected and diluted sample from the first dilution chamber toward an outside of the first dilution chamber for analysis by the analyzer,
a collection tube mounted on the collection inlet, or
a set of at least one collection spout in which each collection spout is configured to be mounted on the collection inlet, or
a set of at least one collection tube one of which is mounted on the collection inlet, and a set of at least one collection spout, in which each collection spout is configured to be mounted on a respective collection tube or on a same collection tube,
in which the collection tube is straight, and has its own axis of elongation coincident with that of the dilution chamber, and parallel to the direction of the gaseous flow in the pipeline.

24. The device according to claim 23, wherein a geometry of the collection tube, the set of at least one collection spout and the outlet tube is configured to make a flow of the collected sample laminar, and an internal geometry of the first dilution chamber is such that it allows turbulence to be created within the first dilution chamber.

25. The device according to claim 24, wherein the first dilution chamber has an ellipsoidal or biconical internal geometry with two revolving cones mounted at ends of a cylinder and with heights that are coincident with each other.

26. The device according to claim 23, further comprising a second dilution chamber located along the outlet tube, wherein the outlet tube constitutes a collection inlet of the second dilution chamber.

27. The device according to claim 23, further comprising a multi-branch intermediate part connected to the outlet tube, the intermediate part comprising at least three branches, one main branch intended to be connected to the outlet tube, and at least two secondary branches, one of which is intended to be connected to at least one analyzer, and the other is intended to be connected to an outlet for discharging the excess of gaseous mixture.

28. The device according to claim 23, further comprising an electrical resistance inserted in a double jacket for controlling a temperature of the collected and diluted sample that passes through the outlet tube.

29. The device according to claim 23, further comprising a heating chamber configured to be placed in the pipeline to set a temperature of the dilution gas before its introduction in the first dilution chamber.

30. The device according to claim 23, further comprising at least one analyzer for analyzing the collected and diluted sample conveyed by the outlet tube and in which,
when the temperature of the gaseous mixture flowing in the pipeline is lower than 300° C., the analyzer is configured to be positioned in the pipeline or outside it, and
when the temperature of the gaseous mixture flowing in the pipeline is higher than 300° C., at least one analyzer is configured to be positioned out of the pipeline.

31. A system for conditioning a sample collected in a gaseous mixture flowing in a pipeline comprising a conditioning device according claim 23 and a source of dry dilution gas being external to the pipeline wherein the dilution gas includes nitrogen.

32. The system according to claim 31, wherein, when the gaseous mixture flowing in the pipeline comprises particles and the dilution gas is clean.
